(19) United States
(12) Patent Application Publication
(10) Pub. No.: US 2009/0271013 A1
(43) Pub. Date: Oct. 29, 2009

(54) Monitor socket, monitor system and control method thereof

(76) Inventor: Hsien-Chung Chen, Zhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,395

(22) Filed: Jul. 3, 2008

(30) Foreign Application Priority Data
Apr. 25, 2008 (TW) 97115450

(51) Int. Cl. G06F 17/00

(52) U.S. Cl. 700/90

(57) ABSTRACT

The present invention provides a control method for a monitor system that can monitor and control electrical equipment from a host. The method comprising the steps of: first, providing a monitor socket which connects the electrical equipment to use a power line to connect to the host via internet; then, the monitor socket detecting the status of the electrical equipment to generate a status information and transmitting it to the host; then the host generating a control information and transmitting it to the monitor socket; finally, the monitor socket controlling the status of the electrical equipment according to the control information.

### BACKGROUND OF THE INVENTION

1. Field of the Invention

The present invention is related to a monitor system and a control method thereof, and more particular to a monitor system and control method thereof that is applicable to a power socket for monitoring and controlling the status of electrical equipment that is coupled to the power socket through a monitor socket.

2. Description of Related Art

Most of the power socket includes multiple female connectors (i.e. usually a power socket includes two female electrical connectors), in order to provide electric power to multiple electrical appliances. In most cases, after the electrical plug of the electrical appliances connects with the power socket, the user would still have to manually operate the electrical appliances, in order to control the on/off status of the electrical appliances. If the user is away and not near the power socket nor near the electrical appliances, then there would be no way to control the on/off status of the electrical appliances, which will lead to unnecessary higher electrical usage, and problems of energy waste.

Furthermore, although the user can manually control the on/off status of the electrical appliance, but the user will not know from mere exterior of the electrical appliance of detailed usage status information such as temperature, power consumption, and electric cost (wherein the electric cost is calculated by the power consumption with an estimated electric rate, i.e. average electric rate over the past year), wherein the lack of such knowledge, coupled with inappropriate power supply, will lead to overheating of electrical appliances, damaging or shorten life span of the sensitive electrical components in the electrical appliances, and increase the frequency in which electrical appliances needs to be replaced.

Therefore, there is now currently household appliance technology in development, which takes advantage of Internet connection to control the on/off status of electrical appliances, wherein a user can deliver a shut-off command through a remote host, in order to control the on/off status of electrical appliances, and further more receive detailed usage status of the electrical appliances. However although remote monitoring of electrical appliances is possible via the above method, but the user must additionally setup internet connection lines on the household socket, in order to allow information of the electrical appliances to be sent to local area network, and then communicate to the remote host via the local area network.

However, setting up internet connection lines can be a major project, especially in older houses or houses located in more remote area, further more the additional cost and time for construction are just some of the limiting factors for this approach. Therefore, how to remotely monitor and control electrical appliances/equipments without setting up internet connection lines is an area of study that is worth researching.

Consequently, because of the technical limitation described above, the applicant strives via real world experience and academic research to develop the present invention, which can effectively improve the limitations described above.

### SUMMARY OF THE INVENTION

Due to the limitations described supra, the present invention provides a socket with a power line communication module (PLC module), so that the status information of electrical equipment that is plugged into the socket can be connect to the internet through the power plug (wherein the power plug is coupled to the power line), and be communicated to a remote host, which satisfies the object of the present invention of not setting up internet communication lines, yet still be able to remotely monitor and control the status of electrical equipments.

To reiterate, the object of the present invention is to provide a monitor socket, which can monitor (i.e. temperature, electric cost, and power consumption) and control (i.e. on/off) the status of electrical equipments.

Another object of the present invention is to provide a monitor system and control method thereof, which can remotely monitor and control the status of electrical equipments.

The present invention discloses a monitor socket, to be used in conjunction with at least a host (i.e. computer) to monitor and control one or more electrical equipments. The monitor socket includes a female connector module, a detection module, a control module, and a communication module. The female connector module includes multiple female connectors and multiple switches, wherein the female connectors corresponds one to one with the switches, the female connectors are used for plugging by the electrical equipments; the detection module, coupled with the female connector module, is used for detecting the operating status of the electrical equipments that has been plugged into the female connector module, and converting the information of the operating status into a status signal; the control module, coupled between the detection module and the female connector module, is used for receiving and transmitting the status signal; the communication module, coupled between the control module and the internet, is used for transmitting the status signal to the internet then onto the host via a power plug (wherein the power plug is coupled to the power line), and the communication module is also used for receiving a control signal transmitted by the host; wherein, the control module will control the switches according to the control signal, in order to control the status (i.e. on/off status or brightness status) of the electrical equipments.

The present invention further discloses a monitor system, used for monitoring and controlling one or more electrical equipments. The monitor system includes a monitor socket and at least a host (i.e. computer). The monitor socket includes a female connector module, the female connector module includes multiple female connectors and multiple switches, wherein the female connectors corresponds one to one with the switches, the female connectors are used for plugging by the electrical equipments; a detection module, coupled with the female connector module, is used for detecting the operating status of the electrical equipments plugged into the female connector module, and converting the information of the operating status into a status signal; a control module, coupled between the detection module and the female connector module, is used for receiving and transmitting the status signal; and a communication module, coupled between the control module and the internet, is used for transmitting the status signal to the internet via a power plug, and the power plug is coupled to a power line. A host is coupled with the internet, and the host is used for receiving the status signal and generating a control signal, and then transmitting the control signal to the monitor socket via the internet. Therein, the control module will control the switches according to the control signal, in order to control the on/off status of the electrical equipments.

In an embodiment of the present invention, the communication module includes an internet control chip unit, used for transmitting status signal and control signal, and for managing status signal and control signal; and a power line communication module (PLC Module), coupled with the internet control chip unit, is used for transmitting the status signal and the control signal between the power plug (wherein the power plug is coupled to the power line) and the internet. And the before mentioned detection module includes a brightness detector unit, used for detecting the brightness of the electrical equipments; a temperature detector unit, used for detecting the temperature of the electrical equipments; and a power detector unit, used for detecting the power consumption of the electrical equipments.

In an embodiment of the present invention, the control signal is periodically generated at the host end, or is generated according to a command given by a user to the host, in order to control the status of the electrical equipments.

The present invention further discloses a control method for a monitor system, used for remote monitoring and controlling one or more electrical equipments by at least a host. The control method includes first, provides a monitor socket, coupled with one or more electrical equipments, and uses a power plug (which is coupled to a power line) to connect to a host via the internet; then, the monitor socket detects the operating status of the electrical equipments and converts the information of the operating status into a status signal, and transmit the status signal to the host; then, the host generates a control signal, and transmits the control signal to the monitor socket; finally, the monitor socket controls the status of the electrical equipments according to the control signal.

In an embodiment of the present invention method, before the monitor socket detects the operating status of the electrical equipments, further includes the following steps: first provide a monitor program for the host; then execute the monitor program, wherein the monitor program requests the monitor socket to detect the operating status of the electrical equipments, in order for the host to receive the initial and subsequent status signal.

Through the technical contents described above, the present invention can remotely monitor (i.e. temperature, electric cost, and power consumption) and control (i.e. on/off) the status of electrical equipment, without setting up internet connection lines, thereby avoid extra cost of setting up additional internet connection lines and avoid the extra electrical cost from having electrical equipments needlessly kept on.

The above summary and the following detailed description with appended drawings are for further understandings of the features and technical contents provided by the present invention. Other objects and advantages of the present invention shall be referenced by the following descriptions and appended drawings. However the appended drawings are merely employed to present the references and illustrations of the present invention, not for imposing any restriction thereon.

### BRIEF DESCRIPTION OF THE DRAWINGS

FIG. 1 is a three-dimensional drawing showing an embodiment of a monitor socket of the present invention;

FIG. 2 is a schematic diagram showing an embodiment of a monitor system of the present invention.

FIG. 3 is an application schematic diagram showing an embodiment of a monitor system of the present invention.

FIG. 4 is an operation flow chart showing an embodiment of a control method for a monitor system of the present invention.

### DETAILED DESCRIPTION OF THE PREFERRED EMBODIMENTS

The present invention provides a monitor socket, monitor system, and control method thereof, which includes a power line communication module (PLC module) within the monitor socket, that can transmit status signal of electrical equipments to the internet through the power plug (wherein the power plug is coupled to the power line), in order to avoid setting up additional internet connection lines, yet still allows for remote monitor and control of electrical equipments. Therein, the electrical equipments are plugged into the monitor socket.

The primary technical feature of the present invention is to have monitor system and method thereof, for a socket which includes a detection module (for monitoring electrical equipments) and a power line communication module (for internet connection), the following description merely describes the necessary system structure and operation, however, to those skilled in the art, other than the below mentioned components, PLC module, and internet connection format, there are other components and protocols that serve the same purpose, and hence, the following embodiments are merely employed to present the references and illustrations of the present invention, not for imposing any restriction thereon.

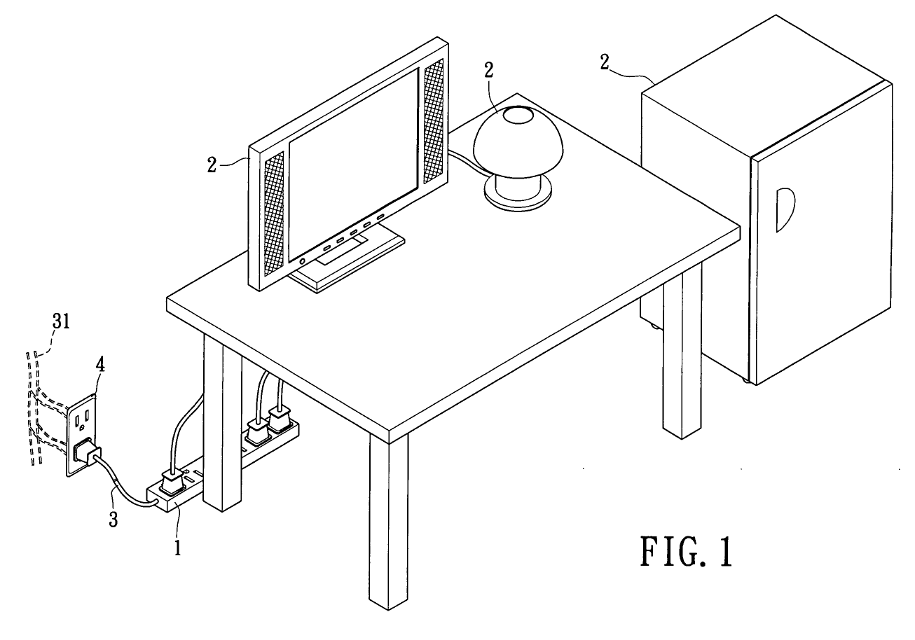

First, please reference FIG. 1, which is a three-dimensional drawing showing an embodiment of a monitor socket of the present invention. As FIG. 1 shows, the monitor socket 1 includes multiple female connectors for plugging by multiple electrical equipments 2; the monitor socket 1 connects to a power socket 4 via a power plug 3, so that the monitor socket 1 receives power and allows the electrical equipment 2 to operate.

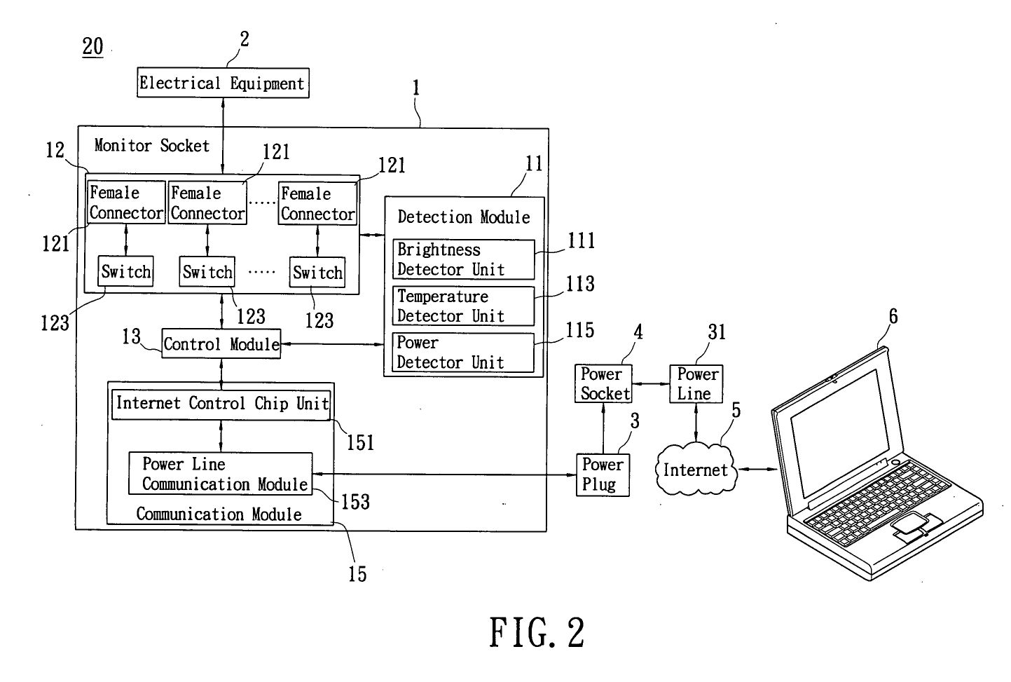

Next, please reference FIG. 2, which is a schematic diagram showing an embodiment of a monitor system of the present invention. Therein, for relating three-dimensional drawings please reference in conjunction with FIG. 1. As FIG. 2 shows, the monitor system 20 includes a monitor socket 1 and a host 6.

The host 6 couples to an internet 5, and via internet 5 transmits a control signal to the monitor socket 1, in order for the host 6 to monitor and control the operating status of the coupled electrical equipments 2. Concretely, the host 6 can be a cell phone, personal digital assistant, desktop computer, notebook computer, server, or workstation; the internet 5 can be Ethernet (i.e. the internet control chip unit uses Ethernet to transmit signal); and the electrical equipment 2 can be any equipment powered electrically and is plugged into the monitor socket.

The monitor socket 1 includes a female connector module 12, a detection module 11, a control module 13, and a communication module 15. The female connector module 12 includes multiple female connectors 121 and multiple switches 123, wherein the female connectors 121 corresponds one to one with the switches 123, and by turning switches 123 on or off, the control of the status (i.e. on or off) of the electrical equipment 2 that is plugged into the respective female connectors 121 can be achieved. The detection module 11, coupled to the female connector module 12, is used for detecting the operating status of the electrical equipment 2 that has been plugged into the female connector module 12, and converting the information of the operating status into a status signal. In an embodiment of the present invention, the detection module 11 includes a brightness detector unit 111, used for detecting the brightness of the electrical equipment 2; a temperature detector unit 113, used for detecting the temperature of the electrical equipment 2; and a power detector unit 115, used for detecting the power consumption of the electrical equipment 2. Concretely, take a table lamp as an example for an electrical equipment 2 that has been plugged into the monitor socket 1, the brightness detector unit 11 can detect the brightness of the table lamp and its on/off status; the temperature detector unit 113 can detect the temperature of the table lamp; and the power detector unit 115 can detect the power consumption of the table lamp. The detection module 11 will collect the above mentioned information of the operating status (i.e. brightness, on/off, temperature, and power consumption information) and convert the information of the operating status into a status signal, and transmit the status signal to the control module 13.

The control module 13, coupled between the detection module 11 and the female connector module 12, is used for receiving the status signal and transmitting the status signal to the host 6, and the control module 13 is also for adjusting the operating status (i.e. on/off or brightness) of the electrical equipment 2 according to the control signal remotely transmitted by the host 6. Concretely speaking, similarly using the above mentioned table lamp as example, if the sky is dark and the brightness detector unit 111 detects the table lamp is off, the detection unit 11 will transmit this information of operating status to the control module 13, which will lead to the turning on of the switch 123, and turns on the table lamp; if the temperature detector unit 113 detects the table lamp is over heated, this information of operating status will be transmitted to the control module 13, which will lead to the turning off of the table lamp; similarly, power detector unit 115 can provide the power consumption information of the electrical equipment 2, so that the monitor socket 1 can be turned on or off according to the power consumption of the electrical equipment 2, in order to control electrical usage.

The communication module 15, coupled with the control module 13, through the power plug 3 that is connected with power socket 4, can connect to the host 6 via the internet 5. In other words, communication module 15 can connect to the host 6 via the internet 5 through the power line 31, since the power line 31 is coupled to the power plug 3. The communication module 15 includes an internet control chip unit 151 and a power line communication module 153. The internet control chip unit 151 is for transmitting status signal and control signal, and for managing status signal and control signal. Concretely, the status signal and the control signal exists in data package format and is transmitted through the internet 5, and the internet control chip unit 151 can be seen as a local area network internet chip (LAN IC), which is responsible for the control of data package flow rate and for the scheduling of data package, in order to ensure the accurate receiving/transmitting of data packages formed by status signal or control signal.

The power line communication module 153, coupled with the internet control chip unit 151, is used for transmitting the status signal to the internet 5 via the power plug 3 (wherein the power plug 3 is coupled with the power line 31), and also for the receiving of the control signal for the monitor socket 1 via the internet 5. Concretely speaking, the power line communication module 153 can connect to the internet via a power system, by converting the above mentioned status signal into a high frequency signal, then used the existing power line to transmit TCP/IP data packages (i.e. the high frequency signal) to the internet 5. Similarly, the power line communication module 153 receives the control signal from the internet 5 through the power plug 3 that is coupled to the power line 31; however signals coming in from a power line generally need to be filtered due to the tendency of power lines to be noisy.

As described above, the communication module 15 will transmit the status signal to the host 6, and the host 6 will generate a control signal according to the status signal, and then transmit the control signal to the communication module 15. The communication module 15 will in turn send the control signal to the control module 13, and the control module 13 will adjust the operating status of the electrical equipment 2 according to the control signal; for example proceed to turn on the table lamp that was originally off, or turn off the television that was originally on. Thus, the monitor socket 1 can communicate to the host 6 via the internet 5, and the host 6 can remotely control the operating status of the electrical equipment 2.

In an embodiment of the present invention, the control signal can be generated periodically from the host 6, in order to provide the function of automatically turning on or off electrical equipment 2; or the control signal can be generated according to a command given by a user to the host 6. The status signal not only includes the before mentioned brightness and temperature information, but also includes the power consumption, electric cost, and on/off information of the electrical equipment 2, and should not be limited to only what has been disclosed by this embodiment. Therein the power consumption and electric cost of the electrical equipment 2 (i.e. table lamp) can be calculated through the brightness and usage time of the electrical equipment 2 by the host 6 along with an estimated electric rate (i.e. the average electric rate over the past year), or can be directly calculated by the control module 13 and then transmitted along with the status signal to the host 6.

In an embodiment of the present invention, the monitor system 20 can include a plurality of host 6 to remotely monitor and control electrical equipment 2, however then the monitor socket 1 will require an extra component that serves the same function as an internet server, so that the hosts 6 can transmit status signal request or control signal depending on needs, and the monitor socket 1 will only need to confirm the IP of the host 6 that had corresponded to the electrical equipment 2, then the status signal produced for the electrical equipment 2 will be transmitted correctly to the corresponding host 6.

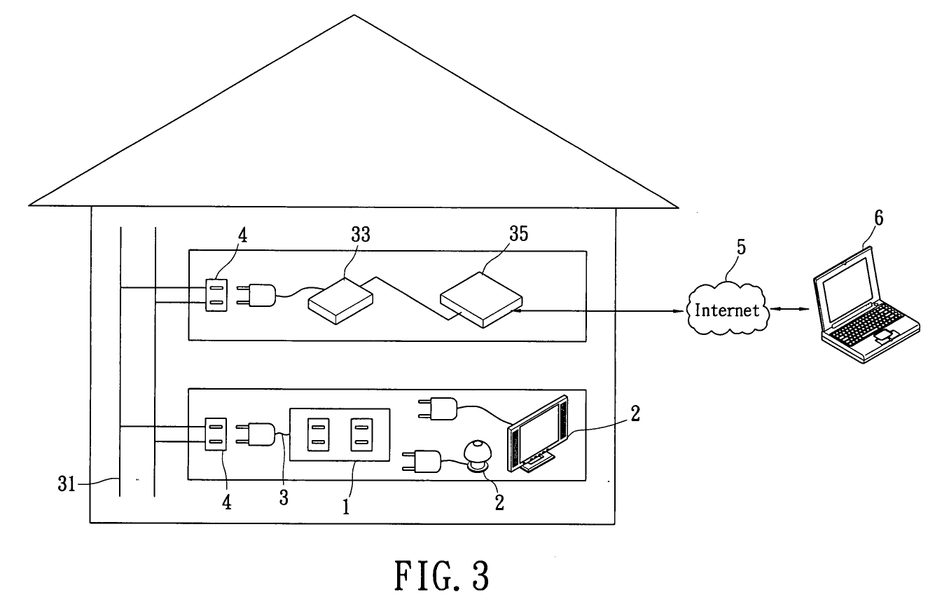

For an application example of the present invention, please reference FIG. 2 in conjunction with FIG. 3, which is an application schematic diagram showing an embodiment of a monitor system of the present invention. As FIG. 3 shows, after an electrical equipment 2 such as a computer has been plugged into a monitor socket 1, then the monitor socket 1 can transmit the status signal via the power socket 4 through the already existing power line 31. Then the power line 31 transmit the status signal to an ADSL modem 35 that has been coupled with a power line communication module 33, thereby the status signal is transmitted to the internet 5 and the host 6. Thus, the monitor socket 1 does not require additional internet connection lines in order to connect to the ADSL modem 35, yet can still connect to the internet 5.

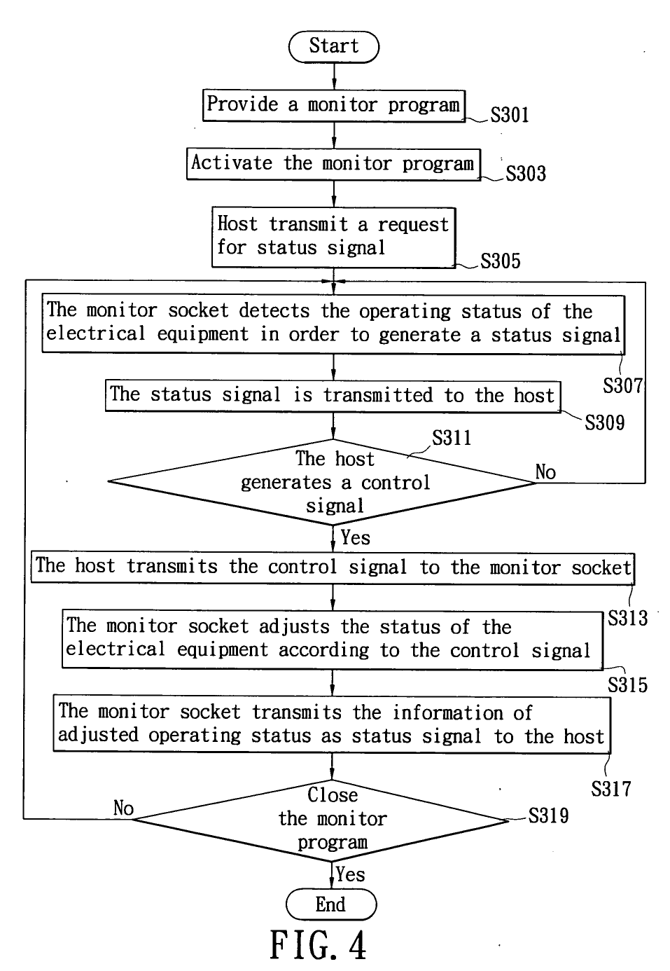

Finally, please reference FIG. 4, which is an operation flow chart showing an embodiment of a control method for a monitor system of the present invention. Therein for the relating system structure please reference in conjunction with FIGS. 1 and 2. As FIG. 4 shows, the control method includes the following steps:

First, provide a monitor program for the host 6 (S301), and activate the monitor program (S303), wherein the monitor program can be automatically executed with the starting of host 6, or can be executed according to a user control; in the initial stage the host 6 has not yet receive the information of operating status (in the form of status signal) for the electrical equipment 2, there will first be a request for status signal from the host 6 to the monitor socket 1 (S305); when the monitor socket 1 receive the request for status signal, the detection module 11 of the monitor socket 1 will detect the operating status of the electrical equipment 2 in order to generate a status signal (S307), and the communication module 15 will connect to the internet 5 via power plug 3 (wherein the power plug 3 is coupled to power line 31), in order to transmit the status signal to the host 6 (S309); once the host 6 receives the status signal, the host may display the information conveyed by the status signal, so that the user can view, analyze, monitor, and remotely control the operating status of the electrical equipment 2.

Then, the control module 13 determines if the host 6 has generated a control signal (S311), wherein the control signal can be generated directly via a user command to the host 6; or the control signal can be generated automatically according to the information of the status signal; or the control signal can be periodically and automatically generated by the host 6; if Step S311 turns out to be NO, then return to Step S07 then continue, and periodically remotely monitor the status of electrical equipment 2; if a control signal is generated, the host 6 will transmit the control signal to the monitor socket 1 via the internet 5 (S313);

Next, the control module 13 of the monitor socket 1 will adjust the status (i.e. on/off or brightness) of the electrical equipment 2 according to the control signal (S315); the detection module 11 will detect the operating status of the adjusted electrical equipment 2, and generate the new status signal to the host 6 (S317)

Finally, the host 6 receives the new status signal, and determines whether to close the monitor program or not (S319); if the answer to Step S319 is yes, then end the whole monitor and control system; if the answer to Step S319 is no, then return to Step S307 and continue, in order to continue monitor and control of the status of the electrical equipment 2.

In an embodiment of the present invention, Step S303 can be followed directly by Step S311, so that the host 6 can directly transmit a control signal to control the electrical equipment 2, and does not need the current operating status of the remotely located electrical equipment 2.

Through the above described embodiments, the monitor socket, monitor system, and control method thereof should have been made clear, by including a power line communication module within the monitor socket, the power line communication module can connect to the internet and transmit signals to a remote host, and via the technique described above, there is no need to additionally set up internet connection lines, yet the user can still remotely monitor and control the operating status of electrical equipments from the remote host through the internet, which leads to reduced cost and achieves the objects of remotely control and monitor of electrical equipment without installing additional internet connection lines.

While the present invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A monitor socket, to be used in conjunction with at least a host to monitor and control one or more electrical equipments, the monitor socket comprising:
a female connector module, comprising of multiple female connectors and multiple switches, wherein the female connectors corresponds one to one with the switches, the female connectors are used for plugging by the electrical equipments;
a detection module, coupled with the female connector module, is used for detecting a operating status of the electrical equipments that has been plugged into the female connector module, and is used for converting the information of the operating status into a status signal;
a control module, couple between the detection module and the female connector module, is used for receiving and transmitting the status signal; and
a communication module, coupled between the control module and the internet, is used for transmitting the status signal to the internet then onto the host via a power plug and the power plug is coupled to a power line, and the communication module is also used for receiving a control signal transmitted by the host;
wherein, the control module will control the switches according to the control signal, in order to control the status of the electrical equipments.

2. The monitor socket according to claim 1, wherein the communication module comprising:
an internet control chip unit, used for transmitting the status signal and the control signal, and for managing the status signal and the control signal; and
a power line communication module (PLC module), coupled with the internet control chip unit, is used for transmitting the status signal and the control signal between the power plug and the internet.

3. The monitor socket according to claim 2, wherein the detection module comprising:
a brightness detector unit, used for detecting the brightness of the electrical equipments;
a temperature detector unit, used for detecting the temperature of the electrical equipments; and
a power detector unit, used for detecting the power consumption of the electrical equipments.

4. The monitor socket according to claim 1, wherein the control signal is periodically generated from the host, or is generated according to a command given by a user to the host, in order to control the status of the electrical equipments.

5. The monitor socket according to claim 1, wherein the host is a cell phone, personal digital assistant, desktop computer, notebook computer, server, or workstation.

6. The monitor socket according to claim 1, wherein the information of the operating status that has been converted into a status signal is the power consumption, electric cost, brightness, temperature, on/off status, or a combination thereof of the electrical equipment.

7. The monitor socket according to claim 2, wherein the internet control chip unit uses Ethernet to transmit signal.

8. A monitor system, used for monitoring and controlling one or more electrical equipments, the monitor system comprising:
a monitor socket, comprising:
a female connector module, comprising of multiple female connectors and multiple switches, wherein the female connectors corresponds one to one with the switches, the female connectors are used for plugging by the electrical equipments;
a detection module, coupled with the female connector module, is used for detecting a operating status of the electrical equipments that has been plugged into the female connector module, and is used for converting the information of the operating status into a status signal;
a control module, couple between the detection module and the female connector module, is used for receiving and transmitting the status signal; and
a communication module, coupled between the control module and the internet, is used for transmitting the status signal to the internet via a power plug and the power plug is coupled to a power line, and the communication module is also used for receiving a control signal transmitted by the host;
at least a host, coupled with the internet, is used for receiving the status signal and generating the control signal, and then transmitting the control signal to the monitor socket via the internet;
wherein, the control module will control the switches according to the control signal, in order to control the status of the electrical equipments.

9. A monitor system according to claim 8, wherein the communication module comprising:
an internet control chip unit, used for transmitting the status signal and the control signal, and for managing the status signal and the control signal; and
a power line communication module (PLC module), coupled with the internet control chip unit, is used for transmitting the status signal and the control signal between the power plug and the internet.

10. The monitor system according to claim 9, wherein the detection module comprising:
a brightness detector unit, used for detecting the brightness of the electrical equipments;
a temperature detector unit, used for detecting the temperature of the electrical equipments; and
a power detector unit, used for detecting the power consumption of the electrical equipments.

11. A control method for a monitor system, used for remote monitoring and controlling one or more electrical equipments by at least a host, the method comprising the following steps:
provide a monitor socket, coupled with one or more electrical equipments, and uses a power plug that is coupled to a power line to connect to a host via the internet;
the monitor socket detects an operating status of the electrical equipments and converts the information of the operating status into a status signal;
the host generates a control signal; and
the monitor socket controls the status of the electrical equipments according to the control signal.

12. The method according to claim 11, further comprising the following steps:
therein after the information of the operating status is converted into a status signal, then the status signal is transmitted to the host; and
therein after the host generates a control signal, then the control signal is transmitted to the monitor socket.

13. The method according to claim 12, wherein before the step where the monitor detects an operating status of the electrical equipments further comprising the following steps:
provide a monitor program for the host;
execute the monitor program, wherein the monitor program requests the monitor socket to detect the operating status of the electrical equipments, in order for the host to receive the initial and subsequent status signal.

14. The method according to claim 11, wherein the control signal is periodically generated from the host, or is generated according to a command given by a user to the host.

15. The method according to claim 11, wherein the control signal is generated according to the status signal.
